(19) United States
(12) Patent Application Publication
(10) Pub. No.: US 2012/0037451 A1
(43) Pub. Date: Feb. 16, 2012

(54) ANCHOR FOR A HEIGHT SAFETY SYSTEM AND HEIGHT SAFETY SYSTEM INCORPORATING AN ANCHOR

(75) Inventors: Peter Payne, New South Wales (AU); Mark Elkins, New South Wales (AU)

(73) Assignee: Safety Compliance Design & Services Pty Ltd, New South Wales (AU)

(21) Appl. No.: 13/260,091

(22) PCT Filed: Mar. 30, 2010
(86) PCT No.: PCT/AU2010/000362

§ 371 Date: Nov. 2, 2011

(30) Foreign Application Priority Data
Mar. 30, 2009 (AU) 2009901356

(51) Int. Cl. E04G 5/00; B23P 11/00

(52) U.S. Cl. 182/112; 29/428

(57) ABSTRACT

Embodiments of anchors for use in height safety systems are described, the anchors including: a generally elongate member; an attachment point for a safety line is provided at one end of the member; the anchor is arranged to be affixed to a sturdy object so that, in use, the attachment point is in a raised position. Various height safety systems including such anchors are also described.

### TECHNICAL FIELD

The present invention relates to the field of safety devices and particularly relates to anchors which provide a mounting point for a height safety system for use in ensuring worker safety when working in or near to potential fall zones.

### BACKGROUND TO THE INVENTION

When working near to a fall zone, such as near to the edge of a raised platform with no railings, there is a significant risk of injury to workers. In order to guard against this, height safety systems can be used such as a fall arrest or fall restraint systems which typically involve attaching a safety line to a worker by way of a harness. A fall restraint system operates to restrain a person from reaching a position where they can fall. A fall arrest system operates to arrest a person's fall in the event of a fall.

When working inside a building, a height safety system can be set-up whereby one end of the safety line is fixed to a sturdy anchor point such as a beam, pillar or other structural building element and the other is fitted to the harness of a worker. However, when working in remote or field locations, there is rarely a suitable sturdy anchor point available to attach the line to.

### SUMMARY OF THE INVENTION

In a first aspect the present invention provides an anchor for use in a height safety system, the anchor including: a generally elongate member; an attachment point for a safety line is provided at one end of the member; the anchor is arranged to be affixed to a sturdy object so that, in use, the attachment point is in a raised position.

The elongate member may include a resilient portion which is arranged to deform in the event of a fall.

The resilient portion may be formed from thermoplastic.

The attachment point may be rotatably mounted to the elongate member.

The anchor may be arranged to be affixed to a towing hitch of a vehicle.

The anchor may be arranged to fit to an upright scaffolding member.

The anchor may further include a second attachment point for a safety line provided proximate to the other end of the elongate member.

In a second aspect the present invention provides a height safety system including an anchor according to the first aspect of the invention and further including stabilising members that extend from the anchor.

The stabilising members may act in tension.

The stabilising members may act in compression.

The height safety system may further include a safety line that is arranged to be strung between the attachment points of the two anchors.

In a third aspect the present invention provides a method of installing a height safety system including the steps of: providing an anchor according to the first aspect of the invention; and attaching the anchor to a vehicle.

The anchor may be attached to the tow hitch of a vehicle.

In a fourth aspect the present invention provides a method of installing a height safety system for performing work on an elevator including the steps of providing an anchor according to the first aspect of the invention; and attaching the anchor to the top side of an elevator.

In a fifth aspect the present invention provides a method of installing a height safety system for performing work assembling or disassembling a scaffold including the steps of providing an anchor according to the first aspect of the invention; and attaching the anchor to an upright portion of the scaffold.

### BRIEF DESCRIPTION OF THE DRAWINGS

An embodiment of the present invention will now be described, by way of example only, with reference to the accompanying drawings, in which:

FIG. 1 is a side view of an embodiment of an anchor for use in a height safety system;

FIG. 2 is a front view of the anchor of FIG. 1;

FIG. 3 illustrates the anchor of FIG. 1 in use with a utility vehicle;

FIG. 4 is a side view of another embodiment of an anchor;

FIG. 5 is a side view of the anchor of FIG. 4;

FIG. 6 is a side view of yet another embodiment of an anchor;

FIG. 7 is a side view of the anchor of FIG. 6;

FIG. 8 is a bracket for use in securing the anchor of FIG. 6 to a vehicle;

FIG. 9 illustrates an adjustable height leg for the anchor of FIG. 6;

FIG. 9 shows the anchors of FIGS. 4 and 6 employed in a height safety system in conjunction with a mining vehicle;

FIG. 11 is a front view of yet another embodiment of an anchor;

FIG. 12 is a side view of the anchor of FIG. 11;

FIG. 13 is a top view of an adaptor for use with the anchor of FIG. 11;

FIG. 14 is a front view of the adaptor of FIG. 13;

FIG. 15 is a front view of a further embodiment of an anchor;

FIG. 16 is an underside view of the anchor of FIG. 15;

FIGS. 17 to 17C illustrate another embodiment of an anchor;

FIG. 18 is a top view of another embodiment of an anchor;

FIG. 19 is a side view of the anchor of FIG. 18; and

FIG. 20 is a perspective view of a height safety system including another embodiment of an anchor.

### DETAILED DESCRIPTION OF THE PREFERRED EMBODIMENT

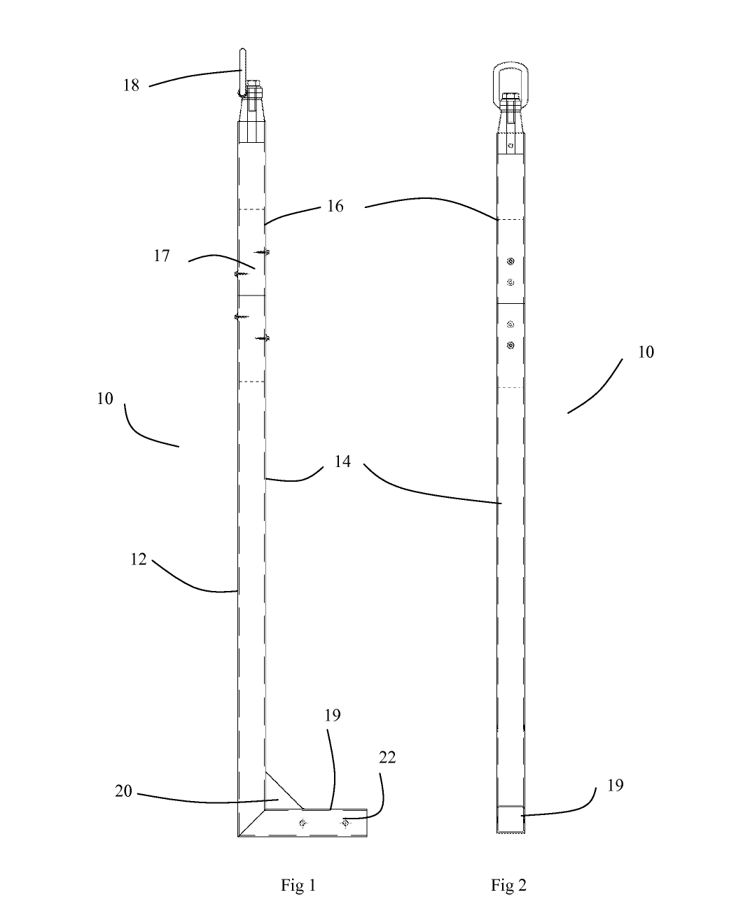

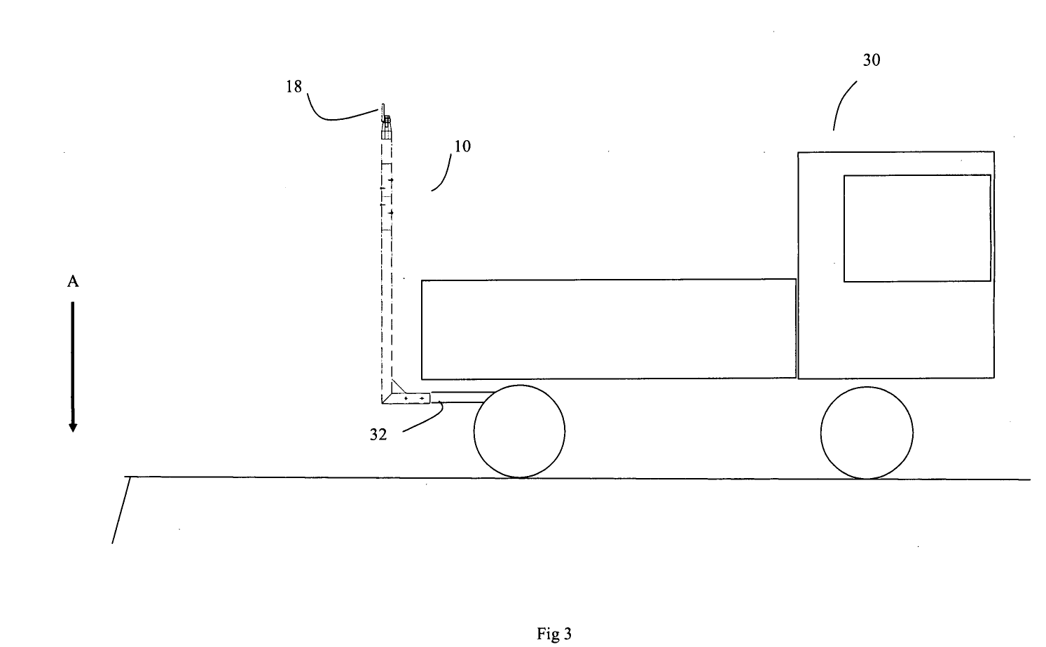

Referring to FIGS. 1 and 2, an anchor 10 is shown for use in a height safety system. The anchor 10 includes an elongate member 12, which is comprised of an upper section 16 which is joined to a lower section 14 by way of a resilient portion in the form of an insert 17 which is formed from thermoplastic material and secured by fasteners. Anchor 10 further includes a horizontal portion 19 which is dimensioned to fit to a standard Hayman Reese type towing hitch as are often found on utility vehicles, four wheel drives, and light trucks. The anchor is secured to the hitch with a locking pin which fits through hole 22. Horizontal portion is welded to upright 14 and is strengthened with a brace plate 20. All of sections 14, 16 & 19 are formed from square section mild steel. Sections 16 and 14 can be separated to take up less storage space for easier stowing of the anchor, such as in the boot of a vehicle. The anchor 10 includes an attachment point in the form of a rud lug 18 which is rotatably mounted to the upper end of the anchor 10 and is free to rotate and to swivel in an up and down direction.

Referring to FIG. 3, a worker wishes to perform some work near to the fall zone, indicated by arrow “A”. The worker sets up a fall restraint system using anchor 10 in the following manner. The worker parks his utility vehicle 30 near to the fall zone “A”. Sections 14 and 16 are joined together using fasteners. Anchor 10 is then affixed to the Hayman Reese type towing hitch 32 already present on the worker's vehicle. The worker puts on a harness and attaches himself with a safety line (not shown) to the rud lug 18. The effective length of the safety line is then adjusted so that the worker cannot reach the fall zone. The anchor 10 allows the utility vehicle 30 to be used as a sturdy object for attaching the safety line. Further, because the rud lug is in a raised position, the line does not present a trip hazard to the worker whilst using the fall restraint system.

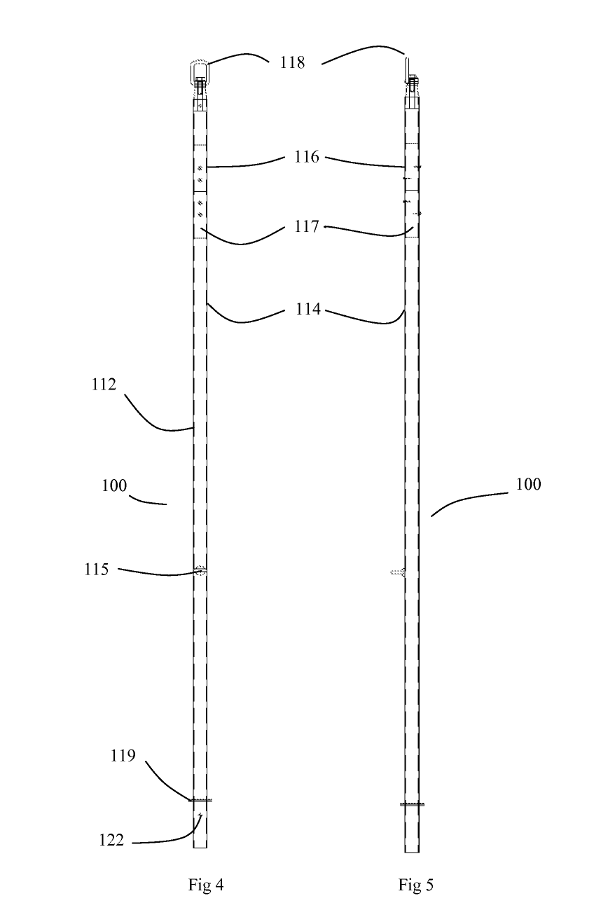

Referring to FIGS. 4 and 5, an alternative embodiment of an anchor will now be described using like reference numerals in the 100 series. This anchor is suitable for use when working on vehicles such as the Eimco type mining vehicle produced by Sandvik AB. Anchor 100 includes an elongate member 112 formed from joined sections 114 and 116 and a first attachment point in the form of rud lug 118 as in the previous embodiment. The sections 114 and 116 are formed from circular section mild steel tube. The sections are joined by way of a thermoplastic insert 117 which is a sliding fit inside sections 114 and 116 and is secured with fasteners. Near to the lower end a second attachment point 115 and a circular flange 119 are provided. The circular tube 116 is selected to be a close fit inside the standard towing hitch provided at the rear of Eimco vehicles. The flange 119 limits the depth of insertion of the anchor 10 into the Eimco towing hitch. A locking pin is inserted through hole 122. The anchor 10 can be used with an Eimco vehicle in a similar manner as described for the utility vehicle above.

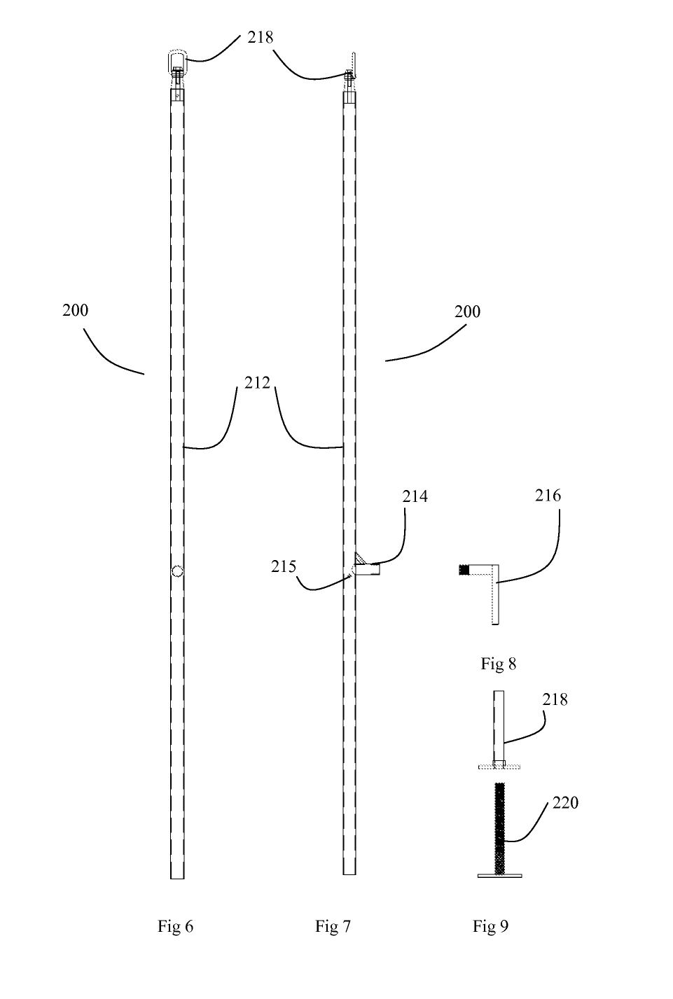

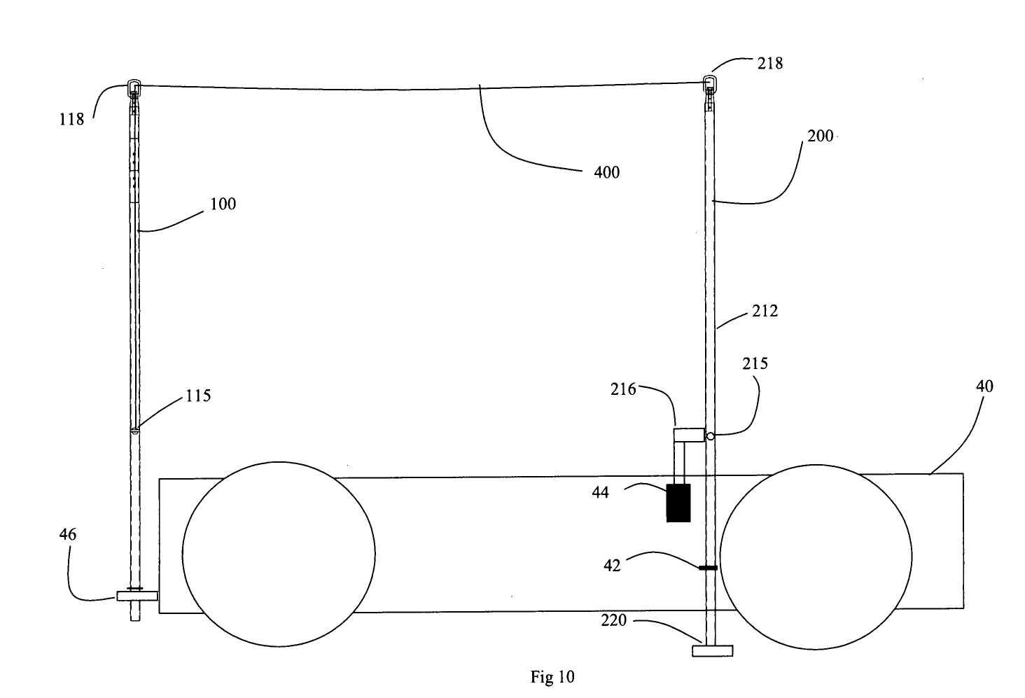

In some cases, a worker may wish to perform work which involves moving around on top of the Eimco vehicle itself. In this case, a height safety system can be used incorporating the anchor of FIGS. 4 and 5, and further incorporating the anchor 200 of FIGS. 6 to 9 which is arranged to be installed towards the front end of an Eimco vehicle.

Referring to FIGS. 6 & 7, a further alternative anchor 200 is shown which again includes an elongate member 212 and a rud lug 218. Anchor 200 includes a threaded stub 214 which receives threaded bracket 216. Anchor 200 further includes a leg of adjustable height formed from threaded stands 218, 220. A hole 215 allows attachment of a threaded bar and clamp.

Referring to FIG. 10, a height safety system incorporating anchors 100, 200 is shown in use with an Eimco vehicle 40. First, a safety line 400 formed from 8 mm diameter wire rope is attached to lug 218 of anchor 200 and the free end of the safety line is threaded through the lug 118 of anchor 100. Anchor 100 is then fitted to the towing hitch 46 as described above. Anchor 200 is fitted towards the front of the vehicle in the following fashion. Member 212 is inserted through a lug 42 which is a standard feature on Eimco vehicles. Member 212 is then fitted over stand 220 which is threaded to allow for height adjustment. Bracket 216 is threaded to member 212, and is then inserted into sleeve 44, again a standard feature of Eimco vehicles. A threaded bar and clamp (not shown) is attached at through hole 215 which clamps against the top of the Eimco vehicle.

Once both anchors 100, 200 are in place, the safety line 400 is pulled tight and attached to attachment point 115. A turnbuckle rated at 2.5 tons is situated between the attachment point 115 and the safety line 400. The turnbuckle allows for the safety line to be tensioned prior to the worker attaching to the safety line. A worker may then attach themselves to the line 400 by way of their own safety line and harness. An inertia reel may be employed as a fall arrest device. The worker may thus perform work on top of the Eimco vehicle 40 and is prevented from falling from the vehicle.

To dismantle the system, safety line is released from attachment point 115 and thereafter disassembly is the reverse of the assembly steps.

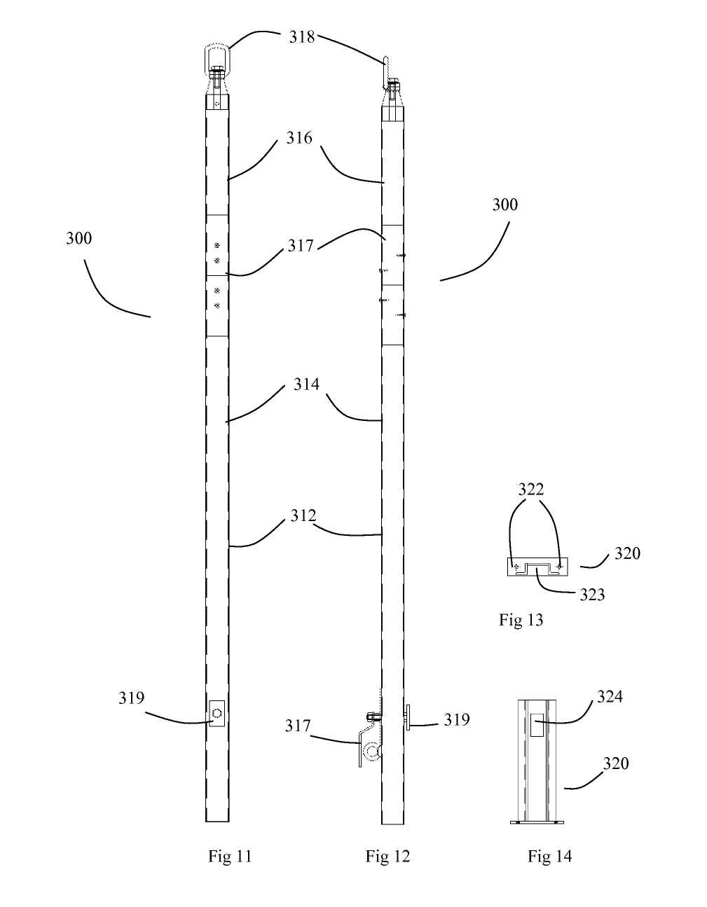

Referring to FIGS. 11 to 14, a still further embodiment of an anchor 300 is shown. This anchor can be used to affix to miscellaneous sturdy objects. Again anchor 300 includes an elongate member 312 formed from upper and lower sections 316, 314 and has a rotatable rud lug 318 at its upper end. This anchor includes a latch mechanism including rotatable handle 317 and keeper 319. An adaptor 320 is provided for mounting the anchor. Adaptor is fitted to a sturdy object by welding or by use of bolts with through holes 322. The mast may then be removably secured to the adaptor 320 by way of inserting the lower end of mast into recess 323 and engaging keeper 319 with aperture 324 by inserting the keeper and rotating handle 317 through 90 degrees. The anchor may then be used to attach a height safety system. After use, the anchor is quickly removed by releasing the latch mechanism.

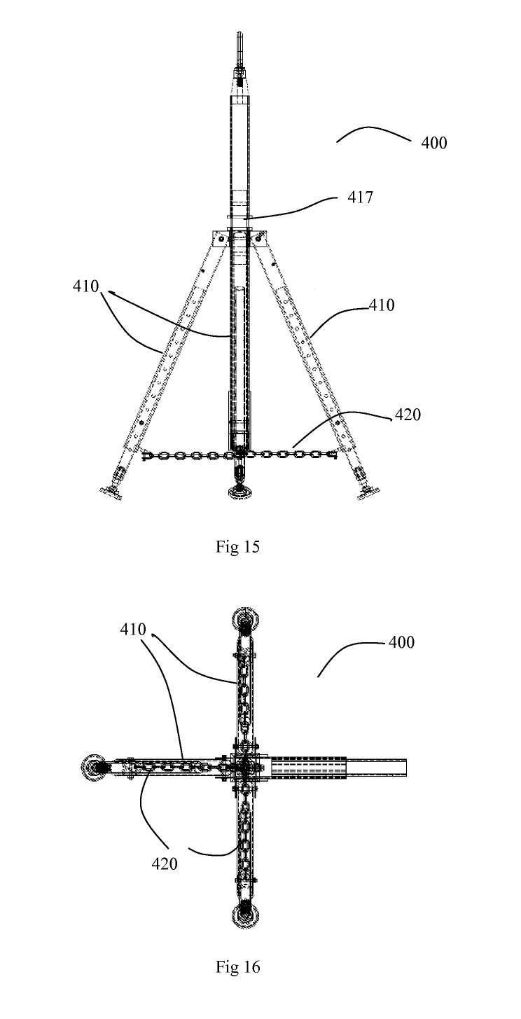

Referring to FIGS. 15 and 16, an anchor 400 for a height safety system is shown. Anchor 400 is intended for attachment to a tow hitch of a vehicle and is a modified version of anchor 10 shown in FIGS. 1 to 3. In this version, three stabilising members in the form of legs 410 extend from the anchor. Each leg is adjustable in length by way of a series of holes and a pin. Each leg is set to the desired length, and a pin is inserted through the corresponding hole. This version is installed in the same manner as the anchor 10 above. Following installation, the legs 410 are spread apart and their length adjusted to bear against the ground. The legs act in compression to stabilise the anchor. The legs 410 are prevented from spreading by way of chain links 420. This version can be used when a fall arrest arrangement is required. The legs 420 provide a tripod arrangement and serve to avoid rolling of the vehicle to which the anchor is attached in the event of a fall or other load applied to the safety line. The elongate portion of the anchor includes an insert of thermoplastic material 417 to absorb energy of shock loads.

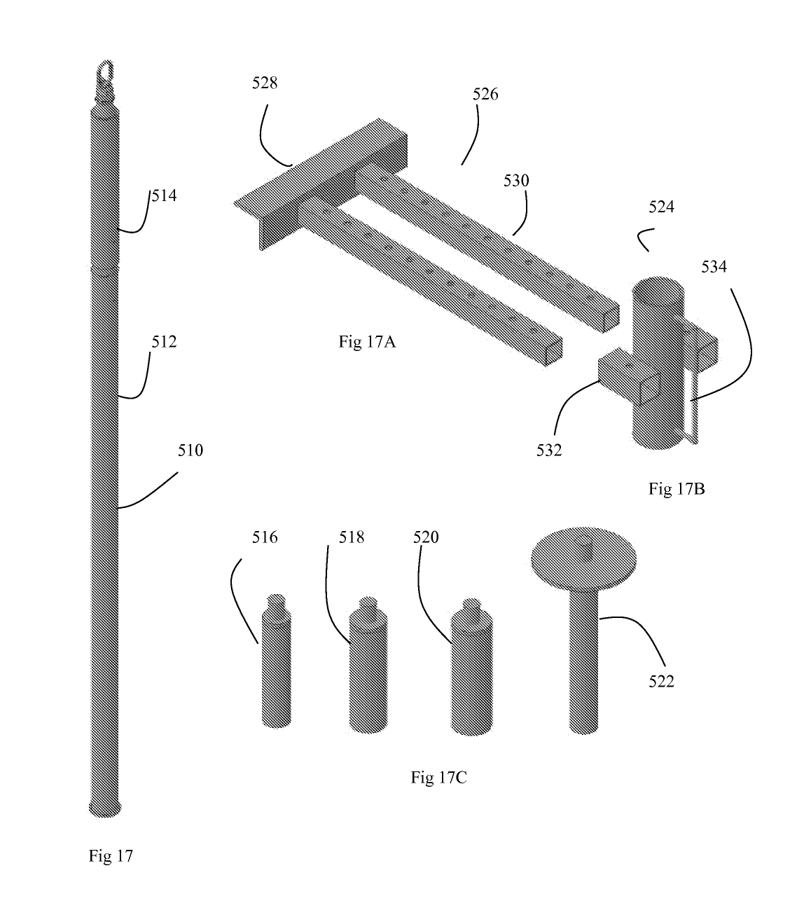

Anchors operating on similar principles to anchors 10, 100, & 400 may be used to attach to other types of vehicles. For instance, referring to FIGS. 17 to 17C, an anchor arrangement is shown which is suitable for attaching to a mining vehicle known as an LHD (Load Haul Dump) vehicle. The arrangement includes an anchor 510 which is formed from lengths 512 and 514, joined by an internal thermoplastic insert (not visible). LHD vehicles are fitted with various types of tow hitches, and a range of tow hitch attachments of various dimensions 516, 518, 520 & 522 are provided. To fit the anchor to an LHD vehicle, the appropriate one of attachments 516, 518, 520 & 522 is selected and fitted to the bottom end of anchor 510 and anchor 510 is fitted to the tow hitch. To stabilise the anchor 510, a sleeve and bracket arrangement is used. Sleeve 524 slides onto anchor 510. Bracket 526 includes a flange 528 which abuts and rests on a wall of the LHD vehicle. The legs 530 of bracket 526 slide into channels 532 of sleeve member 524. A strap and ratchet arrangement is passed through handle 534 of sleeve member 524 and passed about a bodywork or chassis member the LHD vehicle. Locking pins are inserted through the appropriate hole in legs 530 and the strap and ratchet tightened. Anchor 510 is now ready for attachment of a safety line.

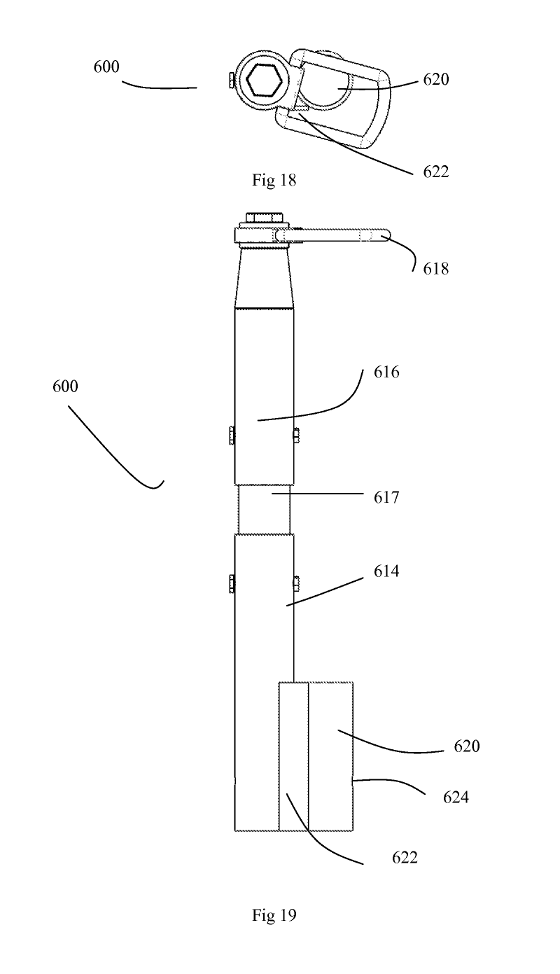

Referring to FIGS. 18 and 19, another embodiment of an anchor 600 is shown. This anchor is intended for use when assembling or disassembling scaffolding. Safety regulations typically provide that workers must use a height safety system when working above a certain height. This height limit is usually exceeded when assembling or disassembling scaffolding. It is sometimes necessary to use a cherry picker or other similar device to ensure worker safety guidelines are met as there is usually no convenient point to attach a height safety system. The anchor 600 solves this problem by providing a raised attachment point 618 for attaching a height safety system.

Anchor 600 includes an upper member 616 and a lower member 614, these are joined by way of an insert of thermoplastic material 617 as for the previously described embodiments and the upper member 616 carries an attachment point in the form of rud lug 618. Anchor 600 further includes a sleeve 620 which is attached to lower member 614 by way of web 622. Sleeve 620, web 622 and lower member 614 are joined by welding.

Scaffolding includes a number of upright members. When assembling or disassembling scaffolding, anchor 600 is fitted to the scaffolding by sliding sleeve 620 over an exposed end of an upright scaffolding member. Anchor may be secured to the upright member by inserting a locking pin through hole 624. A height safety system may then be attached to rud lug 618 with the usual harness attachment to a worker. In the event of a worker falling, then the anchor 600 arrests their fall. As for previously described embodiments, thermoplastic insert may deform to absorb energy and reduce risk of injury to the worker. Also, deformation of the thermoplastic insert acts as a tell tale to indicate that a fall event has occurred.

As the scaffolding is assembled or disassembled, then the anchor 600 is removed and re-fitted higher up, or lower down on the scaffolding as required. Two of anchors 600 may be used so that one of anchors 600 is always affixed to the scaffolding to provide an attachment point for a height safety system.

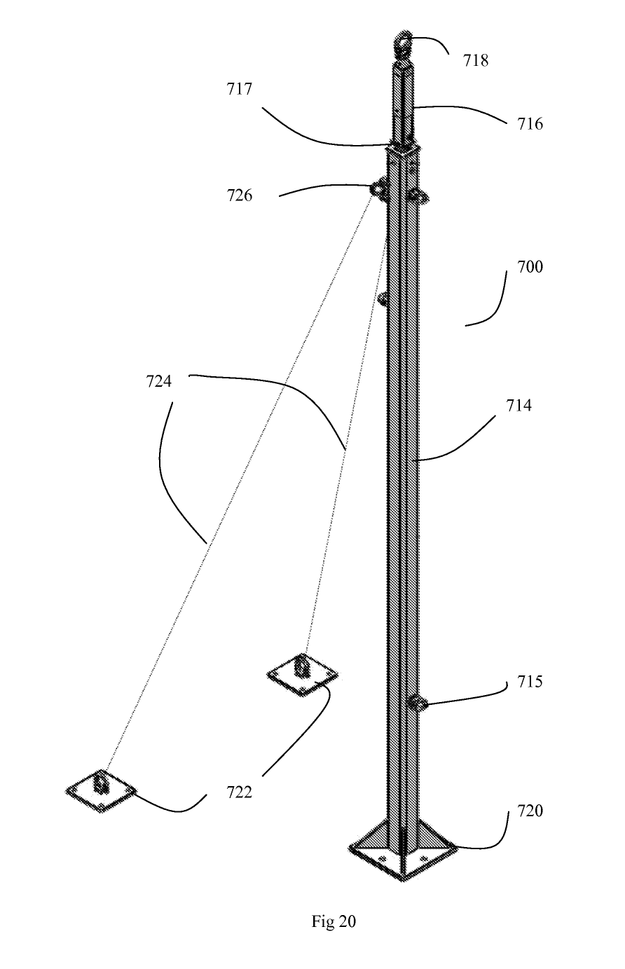

Referring to FIG. 20, another embodiment of an anchor 700 is shown. This anchor is formed from an upper member 716 and a lower member 714. The members are joined by way of a square section thermoplastic insert 717 which fits inside the ends of both of upper and lower members 716, 714 and is secured with fasteners. This anchor is intended for attaching to a workshop floor or other concrete surface by way of base plate 720 through which are inserted into the floor anchors such as dynabolts. Stabilising members in the form of steel cables are provided which are themselves secured to the floor by way of floor plates 722 and dynabolts. The steel cables attach to eyelets 726 which are welded to lower member 714. In use, the steel cables 724 operate in tension.

Anchor 700 is intended for use either with another like anchor, or with another sturdy attachment point, such as a wall of a building, to set up an overhead static safety line will now be described. First, one end of the static line (not shown) is attached to rud lug 718 on one of anchors 700 and the free end is threaded through the rub lug 718 provided on another similar anchor 700. The anchors 700 are then affixed to the floor in the desired location along with floor plates 722 and steel cables 724 are installed and pre-tensioned so that the masts are situated on either side of the potential fall zone. The free end of the static line is then attached to eyelet 715 and pulled tight. The static line is now strung overhead the work area. The static line is used as an attachment point for attaching fall arrest devices, such as inertia reel devices.

The static line may be lowered by releasing the end from eyelet 715 and allowing the line to go slack. If needed, a cord or rope or the like can be attached to the free end of the safety line which can be paid out to lower the safety line to ground level. Lowering the safety line is useful in the event that plant or other tall machinery needs to be moved across the work area that would otherwise foul on the static line. Similarly, the static line can be lowered for attaching or removing inertia reel devices or other safety lines. Workers may thus work in the work area with height safety arrangements in place.

Should a worker fall from a height, the inertia reel locks within about 200 mm of falling. The worker's fall is then broken by the static line. The attachment points 718 experience the shock load of arresting the fall, plus the bending moment of the weight of the fallen person. Thermoplastic inserts 717 of both masts deform under the load on the safety line to absorb the shock loads to prevent these being transferred to the line attachment points or to the worker, via their harness. The deformation of the inserts reduces shock loads and helps reduce the likelihood of injury to the worker as might be caused by a sudden stop in the harness, such as broken ribs or the like.

Testing has demonstrated that an embodiment the overhead static line is suitable to carry a maximum of two persons to a combined weight of 320 kg.

It can be seen that embodiments of the invention have at least the following advantages:
A height safety system can be set up in remote outdoor locations by attaching to a vehicle
The height safety system can be dismantled and stored in the vehicle
A height safety system can be provided to allow for working on top of a vehicle
A height safety system can be provided which can affix to a wide range of sturdy objects
Deformable inserts absorb energy to reduce shock loads and risk of associated injuries. Thus, a worker may avoid medical treatment, and could even continue working on the same day as experiencing a fall event.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. An anchor for use in a height safety system, the anchor including:
a generally elongate member;
an attachment point for a safety line is provided at one end of the member;
the anchor is arranged to be affixed to a sturdy object so that, in use, the attachment point is in a raised position.

2. An anchor according to claim 1 wherein the elongate member includes a resilient portion which is arranged to deform in the event of a fall.

3. An anchor according to claim 2 wherein the resilient portion is formed from thermoplastic.

4. An anchor according to claim 1 wherein the attachment point is rotatably mounted to the elongate member.

5. An anchor according to claim 1 which is arranged to be affixed to a towing hitch of a vehicle.

6. An anchor according to claim 1 which is arranged to fit to an upright scaffolding member.

7. An anchor according to claim 1 further including a second attachment point for a safety line provided proximate to the other end of the elongate member.

8. A height safety system including an anchor according to claim 1 and further including stabilising members that extend from the anchor.

9. A height safety system according to claim 8 wherein the stabilising members act in tension.

10. A height safety system according to claim 8 wherein the stabilising members act in compression.

11. A height safety system including two anchors according to claim 1, the system further including a safety line that is arranged to be strung between the attachment points of the two anchors.

12. A method of installing a height safety system including the steps of:
providing an anchor according to claim 1; and
attaching the anchor to a vehicle.

13. A method according to claim 12 wherein the anchor is attached to the tow hitch of a vehicle.

14. A method of installing a height safety system for performing work on an elevator including the steps of providing an anchor according to claim 1; and
attaching the anchor to the top side of an elevator.

15. A method of installing a height safety system for performing work assembling or disassembling a scaffold including the steps of providing an anchor according to claim 1; and
attaching the anchor to an upright portion of the scaffold.
